(19) United States
(12) Patent Application Publication
(10) Pub. No.: US 2021/0213800 A1
(43) Pub. Date: Jul. 15, 2021

(54) AIR-CONDITIONING SYSTEM FOR AIR-CONDITIONING A SPACE

(71) Applicant: Mahle International GmbH, Stuttgart (DE)

(72) Inventors: Robert Anranter, Schwieberdingen (AT); Markus Wundel, Weissac Im Tal (DE); Andreas Pfander, Weinstadt-Beutelsbach (DE); Greg Rademacher, Waterford, MI (US); Doug Forsyth, Waterford, MI (US); Parag Deshmukh, Amravati (IN); Parag Bhole, Pune (IN)

(21) Appl. No.: 15/999,862

(22) PCT Filed: Feb. 19, 2016
(86) PCT No.: PCT/US2016/018641

§ 371 Date: Aug. 20, 2018

(51) Int. Cl. B60H 1/00

(52) U.S. Cl. CPC B60H 1/00671; B60H 1/00207; B60H 2001/00242; B60H 2001/00707; B60H 1/00842

(57) ABSTRACT

An air-conditioning system may include at least one outlet for discharging an air current into the space, first and second distribution elements for adjusting differing first and second parameters of the system, the first and second distribution elements adjustable over first and second adjusting ranges, respectively, and a cam plate for adjusting the distribution elements and featuring first and second guide structure for adjusting the first and second distribution elements, respectively. The guide structures may be configured such that the first distribution element remains in a predefined position over a predefined first angular range of rotation of the cam plate, and the second distribution element may be adjusted in dependence on a rotational angle of the cam plate in the first angular range of rotation. The first distribution element may be adjusted when the second distribution element is in a predefined position at an end of the second adjusting range.

### CROSS-REFERENCE TO RELATED APPLICATIONS

This application claims priority to International Patent Application No. PCT/US2016/018641 filed on Feb. 19, 2016, the contents of which are incorporated herein by reference in its entirety.

### TECHNICAL FIELD

The present invention pertains to an air-conditioning system for air-conditioning a space, particularly an interior of a motor vehicle. The invention furthermore pertains to a method for operating such an air-conditioning system, as well as to a motor vehicle with such an air-conditioning system.

### BACKGROUND

Air-conditioning systems are used for air-conditioning spaces. In this case, such air-conditioning systems feed an air current to the space in order to air-condition the space. For this purpose, this air current can be tempered, particularly cooled or heated. Air-conditioning systems of this type also make it possible to act upon different zones of the space with said air current.

The optional operating parameters of the air-conditioning system, particularly the adjustable temperatures and/or air distributions, are usually configured by means of control elements that respectively require a separate adjustment. This typically makes it necessary to provide a separate drive for the respective control element or distribution element and therefore leads to a complicated design of the air-conditioning system and/or an increased space requirement and/or an increased weight of the air-conditioning system.

It is also known from the prior art to jointly adjust two such distribution elements.

For example, DE 10 2014 203 850 A1 proposes to adjust two such distribution elements with the aid of a cam plate, wherein said cam plate has corresponding guide structures for the respective distribution elements. In this way, both distribution elements can be adjusted by means of such a common cam plate, wherein a corresponding rotation of the cam plate can be realized with a single drive unit. The adjustments of the distribution elements are therefore always dependent on one another. Consequently, an independent adjustment of corresponding parameters of the air-conditioning system is not possible.

DE 10 2005 056 017 A1 proposes a similar principle, in which two distribution elements are adjusted by means of a common cam plate.

DE 89 03 960 U1 proposes to realize an adjustment of the air distribution between different zones in an interior of a motor vehicle with the aid of a common cam plate that serves for adjusting at least two distribution elements, wherein a rotation of the cam plate always leads to a common adjustment of the at least two distribution elements.

Other air-conditioning systems of this type are known from DE 196 07 652 B4, EP 0 983 884 A1, EP 1 719 645 A1, FR 2 752 775 A1, U.S. Pat. No. 5,062,352 A, US 2007/0111649 A1, DE 101 35 330 A1 and DE 32 24 272 A1.

In all of these air-conditioning systems, an independent adjustment of two such distribution elements therefore requires the use of two drive units or the adjustability of the distribution elements is coupled when such a common drive unit is used such that an independent adjustment of the distribution elements is not possible.

DE 196 43 233 A1 proposes to provide an air-conditioning system with two cam plates and to adjust two such adjusting elements with a respective cam plate, wherein a common drive unit is assigned to both cam plates. In order to rotate the cam plates independently of one another and to thereby independently adjust the distribution elements assigned to the different cam plates, it is furthermore proposed to provide an overrunning clutch, by means of which the drive unit selectively drives one or the other cam plate. Consequently, this solution requires the use of additional components for realizing the clutch and has an increased space requirement.

### SUMMARY

The present invention therefore is based on the objective of disclosing enhanced or at least different embodiments of an air-conditioning system with two distribution elements and a common cam plate, as well as of a method for operating such an air-conditioning system and of a motor vehicle with such an air-conditioning system, wherein said embodiments are particularly characterized by a simplified implementation of an independent adjustment of the distribution elements and/or a reduced space requirement and a reduced weight.

According to the invention, this objective is attained with the object of the independent claims. Advantageous embodiments form the objects of the dependent claims.

The present invention is based on the general idea of adjusting two distribution elements for adjusting at least one parameter of an air-conditioning system by means of a common cam plate, in which guide structures associated with the respective distribution elements are provided, as well as realizing the guide structures in such a way that one of the distribution elements is adjusted over at least an angular range of rotation of the cam plate while the other distribution element remains in a predefined position. Consequently, one distribution element can at least within this angular range of rotation be adjusted without thereby also adjusting the other distribution element. In this way, an independent adjustment of the one adjustable distribution elements is carried out by means of such a common cam plate at least in this angular range of rotation. It is therefore also possible to adjust the distribution elements independently of one another at least in this angular range of rotation without requiring separate cam plates and/or drive units for this purpose. The inventive idea consequently makes it possible to implement an independent adjustment of the distribution elements in a simple, space-saving and weight-reducing fashion.

According to the invention, the air-conditioning system features at least one outlet that serves for discharging an air current into the space to be air-conditioned. The space is therefore air-conditioned by means of said air current. The two aforementioned distribution elements, namely a first distribution element and a second distribution element, are furthermore provided in order to adjust at least one parameter of the air-conditioning system. In this case, the respective distribution elements can be adjusted over an associated adjusting range. This means that the first distribution element can be adjusted over a first adjusting range and the second distribution element can be adjusted over a second adjusting range. The cam plate serves for adjusting both distribution elements, i.e. the first distribution element and the second distribution element. The cam plate is provided with respectively associated guide structures for the adjustment of the distribution elements. The cam plate therefore features a first guide structure for adjusting the first distribution element and a second guide structure for adjusting the second distribution element. According to the invention, the guide structures are realized in such a way that the first distribution element remains in a predefined position over a predefined first angular range of rotation of the cam plate while the second distribution element is in the first angular range of rotation adjusted in dependence on the rotational angle of the cam plate.

The independent adjustment of the second distribution element in the first angular range of rotation in dependence on the rotational angle of the cam plate particularly means that the second distribution element assumes at least at two different rotational angles of the cam plate two different positions within the first angular range of rotation. In this context, it is preferred that the second distribution element is adjusted between different positions at least incrementally, in particular continuously, within the first angular range of rotation.

In the context of the present invention, the stationary state of the first distribution element within the first angular range of rotation is, in contrast to a tolerance-related standstill of the first distribution element, an intentional stationary state of the first distribution element. Accordingly, the first angular range preferably extends over several degrees.

The adjustment of the respective distribution element by means of the respective cam plate or the associated guide structure may basically be realized arbitrarily as long as a stationary state of one distribution element and an adjustment of the other distribution element are realized in the respective angular range of rotation. It would be conceivable to utilize embodiments, in which the respective distribution element is functionally connected to the associated guide structure with the aid of suitable means such as, e.g., levers, rod assemblies and the like.

As mentioned above, the adjustment of the second distribution element in the first angular range of rotation may take place incrementally or continuously. In this case, the adjustment of the second distribution element in the first angular range of rotation may accordingly lead to a continuous or incremental change of the associated parameter of the air-conditioning system.

The at least one outlet of the air-conditioning system serves for discharging the air current into the space. In this case, it is not required that the outlet leads into the space or, e.g., ends at an edge of the space.

It would particularly be conceivable to provide the air-conditioning system with two or more such outlets, e.g., in order to act upon different zones of the space with the air current or a portion of the air current.

If the air-conditioning system is used in a motor vehicle, it would be conceivable, e.g., to respectively assign at least one such outlet to different horizontally or vertically separated zones.

It would basically be conceivable that the first distribution element and the second distribution element serve for adjusting a common parameter of the air-conditioning system. It would particularly be conceivable to adjust such a common parameter in different increments by means of the first distribution element and the second distribution element. For example, a rough adjustment of the parameter may be carried out with the aid of the first distribution element and a precision adjustment of the parameter may be carried out with the aid of the second distribution element or vice versa.

In preferred embodiments, the first distribution element and the second distribution element are provided and, in particular, equipped for adjusting different parameters of the air-conditioning system. This means that the first distribution element is designed for adjusting a first parameter and the second distribution element is designed for adjusting a second parameter of the air-conditioning system that differs from the first parameter. In this way, two independent parameters of the air-conditioning system can also be adjusted independently of one another by means of only one such cam plate.

According to advantageous embodiments, at least one of the distribution elements is used for adjusting an air distribution in the air-conditioning system. It would particularly be conceivable that at least one of the air distribution elements is used for distributing the air current between at least two such outlets. Consequently, the respective distribution element can be used for distributing the air current between two horizontally or vertically separated zones of the space to be air-conditioned. It would particularly be conceivable to use the first distribution element for distributing the air current between horizontally separated zones of the space and to use the second distribution element for distributing the air current between vertically separated zones of the space.

It is furthermore advantageous if at least one of the distribution elements is used for adjusting a temperature of the air current or at least portions of the air current and designed accordingly. For example, the flow of air through a tempering device of the air-conditioning system such as, e.g., a heat exchanger therefore can be varied and changed by means of one of the distribution elements in order to vary the temperature of the air current accordingly. Consequently, the temperature of the air current is also adjusted, in particular, by means of a corresponding air distribution, namely due to a distribution of the air current between a portion flowing through such a tempering device and a portion bypassing the tempering device. In these instances, the respective distribution element may therefore be realized in the form of an air distribution element.

In this context, it is particularly preferred if one of the distribution elements is used for adjusting the air distribution, in particular, between different zones of the space and the other distribution element is used for adjusting the temperature of the air current. In this way, the inventive solution makes it possible to independently adjust the air distribution and/or the temperature by means of such a common cam plate at least in the first angular range of rotation.

The cam plate is advantageously designed in such a way and, in particular, provided with such guide structures that other angular ranges of rotation exist in addition to the first angular range of rotation, wherein one of the distribution element remains in a predefined position in the respective angular range of rotation while the other distribution element is adjusted in dependence on the rotational angle of the cam plate.

It is preferred to provide a second angular range of rotation in addition to the first angular range of rotation, wherein the first distribution element is adjusted in dependence on the rotational angle of the cam plate in the second angular range of rotation while the second distribution element remains in a predefined position. Consequently, the second distribution element is adjusted in the first angular range of rotation while the first distribution element remains in the predefined position whereas the first distribution element is adjusted in the second angular range of rotation while the second distribution element remains in the predefined position. All in all, it is therefore possible to adjust the first distribution element and the second distribution element independently of one another.

It would naturally also be possible to provide a third angular range of rotation, a fourth angular range of rotation, etc., wherein one of the distribution elements remains in a predefined position in the respective angular range of rotation while the other distribution element is adjusted in dependence on the rotational angle of the cam plate as described above.

If multiple angular ranges of rotation are provided, in which one of the distribution element remains in a predefined position, the predefined positions of this distribution element differ between the respective angular ranges of rotation. For example, if the first distribution element remains in a predefined first primary position in the first angular range of rotation and in a predefined second primary position in the third angular range of rotation, the first primary position and the second primary position advantageously differ. In this way, different positions of one distribution element are adjusted in respectively different fixed positions of the other distribution element.

The different angular ranges of rotation are preferably arranged directly adjacent to one another. This means that the second angular range of rotation directly follows the first angular range of rotation. A third angular range of rotation accordingly may directly follow the second angular range of rotation, etc.

The extent of the respective angular ranges of rotation may basically be identical. This means that the first and the second angular range of rotation may respectively extend over the same angle, e.g. 20°, and directly follow one another. Consequently, the first angular range of rotation may extend over a rotational angle of the cam plate between 0° and 20° while the second angular range of rotation extends over a rotational angle between 20° and 40°.

It would naturally also be conceivable that at least two of the angular ranges of rotation over a different angle.

It would be conceivable that the sum of all angular ranges of rotation amounts to 360° such that the end of the last angular range of rotation corresponds to the beginning of the first angular range of rotation. It would also be conceivable that the sum of all angular ranges of rotation amounts to less than 360°.

The angular ranges of rotation, in which the first distribution element remains in the predefined position, and the angular ranges of rotation, in which the second distribution element remains in the predefined position, alternate in preferred embodiments. This makes it possible, in particular, to adjust the second distribution element independently of the first distribution element in the first angular range of rotation and to subsequently adjust the first distribution element independently of the second distribution element, etc.

It is naturally also possible to realize the guide structures in such a way that an angular range of rotation is provided, in which the first and the second distribution element are adjusted.

The adjustable distribution element in the respective angular range of rotation basically can only be adjusted over part of its overall adjusting range in this angular range of rotation. It is preferred that the adjustable distribution element respectively can be adjusted or is adjusted over its entire adjusting range in at least one of the angular ranges of rotation. In this angular range of rotation, it is accordingly possible to adjust the corresponding parameter of the air-conditioning system over its entire adjusting range independently of other parameters. In this way, the temperature of the air current can be adjusted, for example, between a minimum temperature and a maximum temperature at a predefined air distribution. Accordingly, it is thereby also possible, e.g., to arbitrarily adjust the air distribution at a predefined temperature.

As mentioned above, the extent of the respective angular ranges of rotation of the cam plate may be chosen arbitrarily as long as the standstill of the distribution element remaining in the predefined position is not tolerance-related. In conceivable embodiments, a respective angular range of rotation extends over 10° or more.

The first guide structure and the second guide structure basically may be arbitrarily provided on the cam plate as long as the corresponding angular ranges of rotation can thereby be realized.

It would be conceivable to provide the first guide structure and the second guide structure on opposite sides of the cam plate, particularly also opposite faces of the cam plate. In this way, means for functionally connecting the guide structures to the associated distribution element engage into the associated guide structure on opposite sides.

In other conceivable embodiments, the first guide structure and the second guide structure are provided on the same side of the cam plate, particularly on the same face of the cam plate. In this way, the corresponding means for producing the functional connection with the associated distribution element engage into the respectively associated guide structure on the same side of the cam plate.

It would particularly be possible to provide at least one of the guide structures on an edge of the cam plate or along a peripheral edge of the cam plate. In this context, it would be conceivable, in particular, to realize the cam plate similar to a cam lobe.

The rotation of the cam plate for changing the rotational angle of the cam plate and for thereby adjusting the respective distribution element is preferably realized by means of only one common drive unit of the air-conditioning system. Consequently, separate drive units are not required for adjusting the distribution elements in this case.

The drive unit may be motorized and, in particular, realized electrically. The adjustment of the distribution elements and the adjustment of the corresponding parameters can thereby be realized automatically. For this purpose, it would be possible, in particular, to provide a control device that operates the drive unit in accordance with stored specifications and/or manual specifications.

It would also be conceivable to realize the drive unit in such a way that it can be manually actuated. This particularly means that a user of the air-conditioning system can manually actuate the drive unit and thereby at least indirectly turn the cam plate in order to adjust the parameters. This can be realized, e.g., by means of corresponding rotary switches.

The respective distribution element may basically be realized arbitrarily. As mentioned above, the respective distribution element may particularly be realized in the form of an air distribution element. It would also be conceivable to respectively realize at least one of the distribution elements in the form of a flat or to equip at least one of the distribution elements with a flap. In this case, the flat particularly serves for air distribution purposes and accordingly can be used for distributing the air current between at least two such outlets and/or for respectively feeding the air current through or bypassing such a tempering device.

The respective guide structures may basically be realized arbitrarily.

It would particularly be conceivable to realize at least one of the guide structures in the form of a groove in the cam plate such that at least one connecting means can be guided in the groove. It would also be conceivable to realize at least one of the guide structures in the form of a channel that is arranged on the corresponding side or on the edge of the cam plate and open toward the outside such that at least one connecting element for producing the functional connection with the corresponding distribution element can be guided in the channel.

The inventive air-conditioning system is advantageously operated in such a way that a temperature of the air current of the air-conditioning system is adjusted with the first distribution element and an air distribution of the air-conditioning system in different zones of the space to be air-conditioned, particularly an air distribution between at least two such outlets of the air-conditioning system, is adjusted with the second distribution element.

In a preferred embodiment, five such angular ranges of rotation are provided, wherein the air distribution into a first zone of the space is adjusted by means of the first distribution element in the first angular range of rotation. In this case, the first distribution element remains in a predefined primary position in the first angular range of rotation such that the air distribution is not changed and takes place, e.g., into a first zone of the space. The first zone of the space may consist, in particular, of a corresponding zone of an associated interior of a motor vehicle such as, e.g., a deicing or defrost zone. In the first angular range of rotation, the temperature of the air current of the air-conditioning system is furthermore adjusted by means of the second distribution element in dependence on the rotational angle of the cam plate in the first angular range of rotation. In this context, it is preferred that the temperature of the air current is in the first angular range of rotation adjusted between a minimum temperature and a maximum temperature and therefore over the entire adjusting range of the second distribution element. In the second angular range of rotation, which directly follows the first angular range of rotation, the second distribution element remains in a predefined secondary position such that the temperature of the air current essentially remains constant. The first distribution element can be adjusted in the second angular range of rotation such that the air distribution varies, e.g., between the first zone and a uniform distribution into the first zone and a second zone of the space in dependence on the rotational angle of the cam plate. The second zone of the space may consist, in particular, of a center console region in the interior of the associated vehicle. The temperature of the air current therefore remains constant within the second angular range of rotation while the air distribution can be varied between the first zone only and a uniform distribution into the first zone and the second zone. In the third angular range of rotation that follows the second angular range of rotation, the first distribution element remains in such a predefined secondary position, wherein this secondary position of the first distribution element corresponds to the position at the end of the second angular range of rotation, e.g., in which a uniform air distribution into the first and the second zone of the space takes place. The second distribution element can be adjusted in the third angular range of rotation in order to thereby once again vary the temperature of the air current. In this case, the temperature of the air current is preferably varied from the minimum temperature to the maximum temperature. This means that the first and the second zone are uniformly acted upon with the air current in the third angular range of rotation while the temperature of the air current can be adjusted over the entire adjusting range, namely between the minimum temperature and the maximum temperature. In the fourth angular range of rotation that follows the third angular range of rotation, the second distribution element once again remains in such a predefined secondary position, wherein this secondary position may correspond to the position, in which the maximum temperature of the air current is adjusted. The first distribution element can be adjusted in the fourth angular range of rotation such that the air distribution can be varied between the uniform distribution into the first zone and the second zone and a distribution into the second zone only by means of the first distribution element in dependence on the rotational angle of the cam plate. In the fourth angular range of rotation, the temperature of the air current therefore remains, e.g., at the maximum temperature while the air distribution can be varied between a uniform distribution into both zones and a distribution into the second zone only. In the fifth angular range of rotation that follows the fourth angular range of rotation, the first distribution element once again remains in such a predefined primary position, wherein this primary position corresponds, e.g., to the position, in which the air distribution takes place into the second zone only. The second distribution element can be adjusted in the fifth angular range of rotation, wherein the second distribution element is adjusted in dependence on the rotational angle of the cam plate in order to change the temperature of the air current of the air-conditioning system. In the fifth angular range of rotation, the temperature of the air current is preferably adjusted from the maximum temperature to the minimum temperature. This means that only the second zone can be acted upon with the air current in the fifth angular range of rotation and the temperature of the air current preferably can be adjusted over the entire adjusting range, namely from the maximum temperature to the minimum temperature. This makes it possible to realize all possible combinations of the air distribution and the air current temperature with only one such cam plate and only one such common drive unit.

The temperature of the air current naturally can be adjusted over the entire adjusting range in the respective angular range of rotation, i.e. in the first, third and fifth angular range of rotation. The air distribution is adjusted in the other angular ranges of rotation, i.e. in the second and the fourth angular range of rotation, wherein the air distribution is varied from a distribution into the first zone only to a uniform distribution into both zones in the second angular range of rotation and from the uniform distribution into both zones to a distribution into the second zone only in the fourth angular range of rotation. A reversed adjustment of the temperature and the air distribution would naturally also be conceivable.

The inventive air-conditioning system and the inventive method can be used in arbitrary applications.

It would particularly be conceivable to use the air-conditioning system in a motor vehicle in order to air-condition the interior of the motor vehicle.

The air-conditioning system is advantageously controlled by means of a control device of the motor vehicle or a control device of the air-conditioning system. In this case, the control is particularly realized in accordance with the above-described method.

The distribution elements may basically be used for adjusting arbitrary parameters of the air-conditioning system of the motor vehicle. In conceivable embodiments, e.g., the first distribution element and the second distribution element adjust parameters of the air-conditioning system in a front region of the motor vehicle, i.e. in the region of the driver of the motor vehicle. It would also be conceivable that the first distribution element and the second distribution element adjust parameters in a front region and/or in a rear region of the motor vehicle.

In this case, the distribution elements are preferably used for adjusting the temperature of the air current and the air distribution. This means that the first distribution element is in preferred embodiments used for adjusting the air distribution and the second distribution element is used for adjusting the temperature of the air current or vice versa.

It is naturally also possible to adjust the air distribution between more than two different zones of the space, particularly the interior of the motor vehicle, by means of the first distribution element.

It furthermore goes without saying that three or more such distribution elements can also be adjusted with the aid of the cam plate. An associated guide structure is assigned to the respective distribution elements. In this case, at least two of the distribution elements remain in a predefined position in at least one angular range of rotation while at least one other distribution element is adjusted in dependence on the rotational angle of the cam plate in this angular range of rotation.

Other important characteristics and advantages of the invention result from the dependent claims, the drawings and the corresponding description of the figures with reference to the drawings.

It goes without saying that the respective characteristics described above and below can not only be used in the respectively cited combination, but also in other combinations or individually without deviating from the scope of the present invention.

Preferred exemplary embodiments of the invention are illustrated in the drawings and described in greater detail below, wherein identical or similar or functionally identical components are identified by the same reference symbols.

### BRIEF DESCRIPTION OF THE DRAWINGS

In the respectively schematic drawings,

FIG. 1 shows a section through a motor vehicle,

FIG. 2 shows a section through an air-conditioning system of the motor vehicle,

FIG. 3 shows a three-dimensional view of part of the air-conditioning system,

FIG. 4 shows a front view of a cam plate of the air-conditioning system,

FIG. 5 shows a side view of the cam plate,

FIG. 6 shows a front view of the cam plate according to another exemplary embodiment,

FIG. 7 shows a rear view of the cam plate according to FIG. 6, and

FIGS. 8 and 9 show diagrams for elucidating the operation of the air-conditioning system.

### DETAILED DESCRIPTION

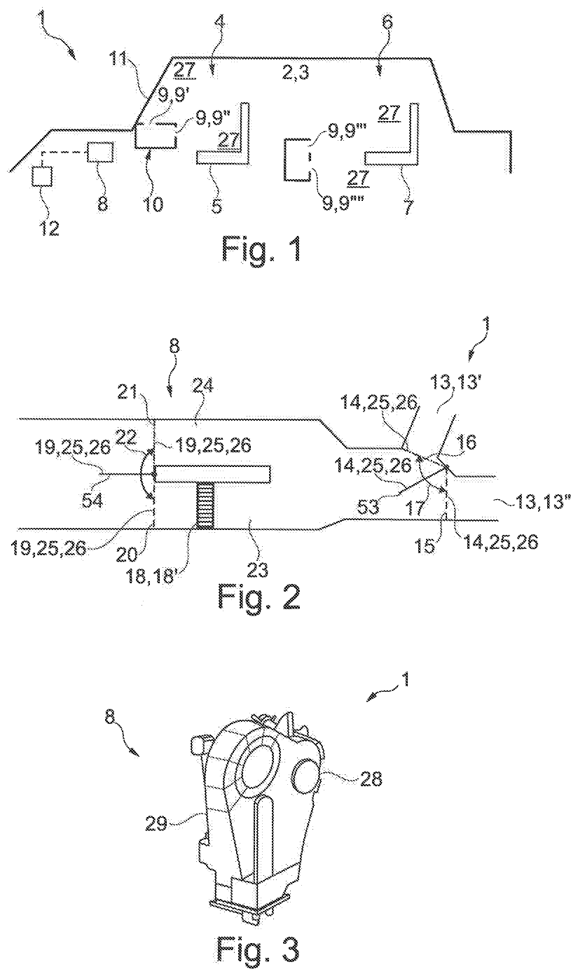

FIG. 1 shows a motor vehicle 1 in the form of a schematic and highly simplified illustration. The motor vehicle 1 respectively features a space 2 or interior 3. At least one front seat 5 for the driver of the motor vehicle 1 is arranged in a front region 4 of the interior 3. At least one rear seat 7, e.g., for a passenger is arranged in a rear region 6.

The motor vehicle 1 is equipped with an air-conditioning system 8 for air-conditioning the interior 3 as indicated in FIG. 1. In this case, the interior 3 is air-conditioned by feeding an air current into the interior 3. Different inlets 9 are provided in the interior 3 in order to discharge the air current into the interior 3. In the region of an instrument panel 10, for example, at least one such inlet 9, 9′ is assigned to a front windshield 11 of the motor vehicle 1 and at least one such inlet 9, 9″ is assigned to at least one of the passengers of the motor vehicle 1 seated in the front region 4. It would also be conceivable to provide at least one additional inlet 9 that is assigned to a foot region. Another inlet 9, 9′ of this type is provided in the rear region 6 and assigned to at least one passenger seated in the rear region. Furthermore, at least one additional inlet 9, 9″ is provided for the foot region of at least one passenger seated in the rear region 6. The respective inlet 9 is therefore assigned to an associated zone 27 of the interior 3. The air-conditioning system 8 is fluidically connected to at least two such inlets 9 in order to feed the air current into the interior 3. The motor vehicle 1 furthermore features a control device 12 for controlling the air-conditioning system 8, wherein the control device 12 may form part of the air-conditioning system 8.

FIG. 2 shows a section through the air-conditioning system 8. The air-conditioning system 8 features at least one outlet 13, wherein the air-conditioning system 8 features two such outlets 13 in the example shown. The respective outlet 13 serves for feeding the air current into the interior 3 or the space 2 and therefore is fluidically connected to at least one such inlet 9 or forms such an inlet 9. For example, the outlet 13, 13′ respectively may be fluidically connected to or correspond to the inlet 9′ while the outlet 13″ may respectively correspond to the inlet 9″ or be fluidically connected to the inlet 9″. Analogously, the outlet 13′ may be fluidically connected to the inlet 9′″ or correspond to the inlet 9′″ while the outlet 13″ corresponds to the inlet 9″ or is fluidically connected to the inlet 9″. The respective outlet 13 of the air-conditioning system is accordingly also assigned to such a zone 27.

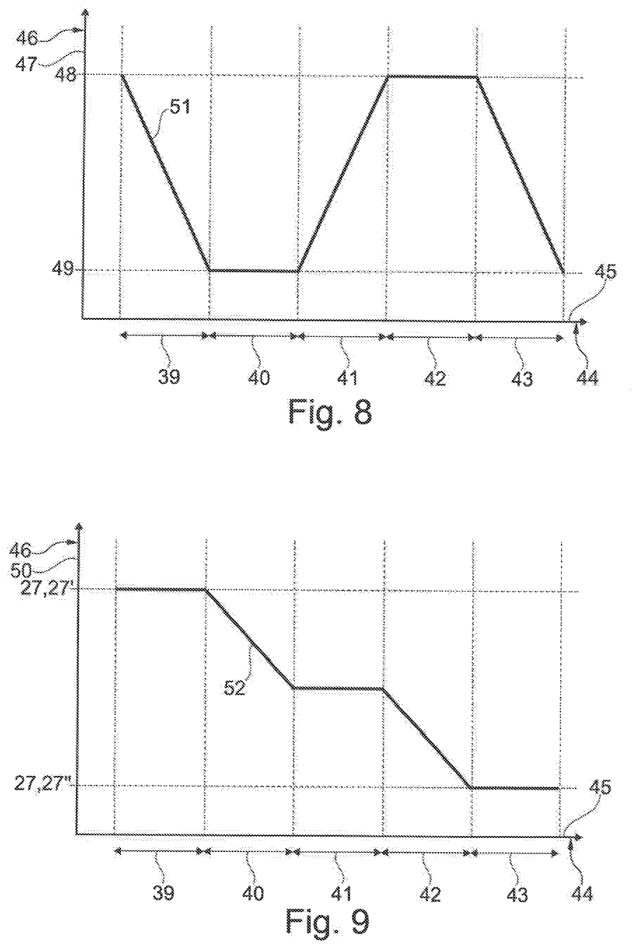

The air-conditioning system 8 features a first distribution element 14 for the air distribution between the outlets 13′, 13″, wherein this first distribution element can be continuously adjusted between a first position 15 illustrated with a broken line and a second position 16 illustrated with a dot-dash line. The first position 15 and the second position 16 therefore define an adjusting range 17 or a first adjusting range 17 of the first distribution element 14. In this case, the first distribution element 14 closes the outlet 13″ and opens the outlet 13′ in the first position 15 while the first distribution element 14 closes the outlet 13′ and opens the outlet 13″ in the second position 16. In FIG. 2, the first distribution element 14 is illustrated with a continuous line in an intermediate position 53, in which a uniform air distribution between the outlets 13 is adjusted. Consequently, a parameter 50 of the air-conditioning system 8 in the form of the air distribution 50 (see FIGS. 8 and 9) is adjusted with the aid of the first distribution element 14.

A tempering device 18 for tempering the air current is provided upstream of the outlets 13. The tempering device 18 may be realized, in particular, in the form of a heat exchanger 18′ and respectively serve for heating or cooling the air current and thereby air-conditioning the interior 3. A second distribution element 19 of the air-conditioning system 8 is arranged upstream of the tempering device 18. The second distribution element 19 can be continuously adjusted between a first position 20 illustrated with a broken line and a second position 21 illustrated with a dot-dash line. The first position 20 and the second position 21 therefore respectively define an adjusting range 22 of the second distribution element 19 or a second adjusting range 22. In the first position 20 of the second distribution element 19, the flow of the air current through the tempering device 18 is prevented by closing a flow-through channel 23, in which the tempering device 18 is arranged, wherein a bypass channel 24 extending around the tempering device 18 is opened in the first position 20 such that the entire air current flows through the bypass channel 24. In the second position 21 of the second distribution element 19, the bypass channel 24 is completely closed such that the entire air current flows through the tempering channel 23 and therefore passes through the tempering device 18 in order to be tempered. In the intermediate position 54 of the second distribution element 19 that is illustrated with a continuous line, the air current is uniformly distributed between the tempering channel 23 and the bypass channel 24. The second distribution element 19 therefore serves for adjusting a temperature 47 of the air current (see FIGS. 8 and 8).

The first distribution element 14 and the second distribution element 19 therefore respectively consist of air distribution elements 25 or are designed for distributing the air current and may be respectively realized, in particular, in the form of a flap 26 or feature such a flap 26.

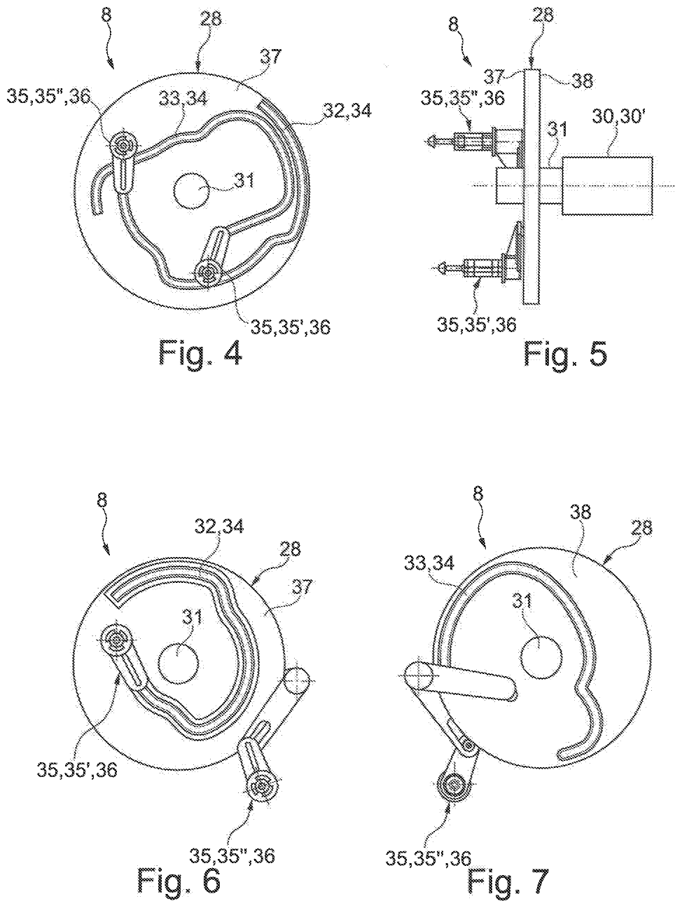

FIG. 3 shows part of the air-conditioning system 8 that is partially illustrated in the form of an exploded view. This figure particularly shows a cam plate 28 and a housing 29, in which a drive unit 30 (see FIG. 5) for rotating the cam plate 28 may be arranged.

FIG. 4 shows a front view of the cam plate 28 and FIG. 5 shows a side view of the cam plate 28. The cam plate 28 is connected in a rotationally rigid fashion to a shaft 31 turned by the drive unit 30, which may particularly consist of an electric drive unit 30′, in order to correspondingly rotate the cam plate 28. The drive unit 30 therefore rotates the cam plate 28 between different rotational angles 45 (see FIGS. 8 and 9). The cam plate 28 features a first guide structure 32 and a second guide structure 33, wherein the first guide structure 32 serves for adjusting the first distribution element 14 while the second guide structure 33 serves for adjusting the second distribution element 19. In the exemplary embodiment shown, the guide structures 32, 33 are respectively realized in the form of a groove 34 in the cam plate 28. The respective distribution element 14, 19 is functionally connected to the associated guide structure 32, 33 in order to adjust the corresponding distribution element 14, 19. This means that at least one first connecting means 35, 35′ functionally connects the first distribution element 14 to the first guide structure 32 while at least one second connecting means 35″ functionally connects the second distribution element 19 to the second guide structure 33. In FIGS. 4 and 5, such a first connecting means 35′ and such a second connecting means 35″ are respectively illustrated in the form of a lever 36 that forms part of the functional connection and is respectively guided in the associated guide structure 32, 33, wherein the configuration and the design of the guide structures 32, 33 leads to a corresponding adjustment of the associated distribution element 14, 19. In the exemplary embodiment illustrated in FIGS. 4 and 5, the first guide structure 32 and the second guide structure 33 are provided on a visible front side 37 and therefore on the same side 37 of the cam plate 28. This means that a rear side 38 (see FIG. 7) of the cam plate 28, which faces away from the front side 37, does not contain any such guide structures 32, 33 for adjusting the first distribution element 14 or the second distribution element 19.

FIG. 5, in particular, also shows that both levers 36 protrude from the cam plate 28 on the front side 37.

FIGS. 6 and 7 show another exemplary embodiment of the cam plate 28 or the air-conditioning system 8, respectively. In this exemplary embodiment, the guide structures 32, 33 are arranged on opposite sides of the cam plate 28. In the example shown, the first guide structure 32 is provided on the front side 37 while the second guide structure 33 is provided on the opposite rear side 38. FIG. 6, in particular, shows that both levers 36 also protrude from the front side 37 of the cam plate 28 in this exemplary embodiment.

The drive unit 30 therefore rotates the cam plate 28 in order to adjust a rotational angle of the cam plate 28. In this case, the guide structures 32, 33 are realized in such a way that one of the distribution elements 14, 19 remains in a predefined position in at least one angular range of rotation 39, 40, 41, 42, 43 of the cam plate 28 and the other distribution element 14, 19 is adjusted in dependence on the rotational angle 45 of the cam plate 28 within this angular range of rotation 39, 40, 41, 42, 43. Five such angular ranges of rotation 39, 40, 41, 42, 43 are provided in the exemplary embodiment shown.

An exemplary functionality or an exemplary operating mode of the air-conditioning system 8 is elucidated below with reference to FIGS. 8 and 9. FIGS. 8 and 9 respectively show a diagram, in which the x-axis 44 shows the rotational angle 45. The x-axes in FIGS. 8 and 9 correspond to one another. The angular ranges of rotation 39, 40, 41, 42, 43 are indicated along the x-axis 44, wherein these angular ranges of rotation consists of a first angular range of rotation 39, a second angular range of rotation 40 that directly follows the first angular range of rotation 39, a third angular range of rotation 41 that directly follows the second angular range of rotation 40, a fourth angular range of rotation 42 that directly follows the third angular range of rotation 41 and a fifth angular range of rotation 43 that directly follows the fourth angular range of rotation 42. In FIG. 8, the temperature 47 of the air current of the air-conditioning system 8 is plotted on the y-axis 46, wherein the temperature 47 of the air current of the air-conditioning system 8 can be adjusted between a maximum temperature 48 and a minimum temperature 49. The temperature 47 of the air current is adjusted by means of the second distribution element 19 as described above. The y-axis 46 in FIG. 9 respectively shows the distribution of the air current between the outlets 13 or the air distribution 50 of the air-conditioning system 8, wherein the air distribution 50 is realized by means of the first distribution element 14 as described above and can be adjusted between a distribution into a first zone 27, 27′ only and a distribution into a second zone 27, 27″ only. The adjustment of the temperature 47 between the maximum temperature and the minimum temperature 49 therefore corresponds to the second adjusting range 22 of the second distribution element 19 while the adjustable distribution between the zones 27, 27″ corresponds to the first adjusting range 17 of the first distribution element 14.

In the example shown, the angular ranges of rotation 39, 40, 41, 42, 43 are respectively chosen identically, i.e. the angular ranges of rotation 39, 40, 41, 42, 43 respectively extend over the same angle, wherein this angle lies at approximately 70° in the exemplary embodiment shown such that the sum of all angular ranges of rotation 39, 40, 41, 42, 43 amounts to approximately 350°.

The first angular range of rotation 39 therefore extends between a rotational angle 45 of 0° to 70°, the second angular range of rotation 40 extends between a rotational angle 45 of 70° to 140°, etc., wherein the fifth angular range of rotation 43 ultimately extends from 280° to 350°.

According to FIGS. 8 and 9, the temperature 47 uniformly decreases from the maximum temperature 48 to the minimum temperature within the first angular range of rotation 39. This variation of the temperature 47 is caused by an adjustment of the second distribution element 19 for adjusting the temperature 47 of the air current from the first position 20, in which the entire air current is conveyed around the tempering device 8 through the bypass channel 24, into the second position 21, in which the entire air current flows through the tempering device 18, within the first angular range of rotation 39. In this case, it is assumed that the tempering device 18 cools the air current. If the tempering device 18 serves for heating the air current, the adjustment of the second distribution element 19 is reversed, i.e. the second distribution element 19 is adjusted from the second position 21 into the first position 20. The temperature profile or the march of temperature 47 is respectively illustrated with a continuous line 51 in FIG. 8 while the air distribution profile is illustrated with a continuous line 52 in FIG. 9.

According to FIG. 9, only the first zone 27′ is acted upon with the air current of the air-conditioning system 8 in the first angular range of rotation 39. This means that the first distribution element 14 for adjusting the air distribution 50 remains in the first position 15, which therefore corresponds to a predefined position 15, in the first angular range of rotation 39. Consequently, the second distribution element 19 is adjusted in dependence on the rotational angle 45 of the cam plate 28 in the first angular range of rotation 39 while the first distribution element 14 remains in the predefined position 15.

In the second angular range of rotation 40, which directly follows the first angular range of rotation 39, the temperature 47 of the air current remains at the minimum temperature 49. The second distribution element 19 therefore remains in the second position 21, which corresponds to a predefined position 21 of the second distribution element 21, in the second angular range of rotation 40. According to FIG. 9, the air distribution 50 is within the second angular range of rotation 40 adjusted from a distribution into the first zone 27′ only to a uniform distribution into the first zone 27′ and the second zone 27″. This means that the first distribution element 14 for adjusting the air distribution 50 is in the second angular range of rotation 40 adjusted from the first position 15 into the intermediate position 53, in which the air current is uniformly distributed between the outlets 13. In this case, the change of the air distribution 50 in the second angular range of rotation 40 takes place uniformly. The first distribution element 14 therefore is adjusted in dependence on the rotational angle 45 of the cam plate 28 in the second angular range of rotation 40 while the second distribution element 19 remains in the predefined position 21.

In the third angular range of rotation 41, which directly follows the second angular range of rotation 40, the temperature 47 of the air current is increased from the minimum temperature 49 to the maximum temperature 48 as shown in FIG. 8. In this case, the change of the temperature 47 in the third angular range of rotation 41 takes place uniformly. This means that the second distribution element 19 is adjusted from the second position 21 into the first position 20 in the third angular range of rotation 41. According to FIG. 9, the air distribution 50 remains at the uniform distribution into the first zone 27′ and the second zone 27″ in the third angular range of rotation 41. This means that the first distribution element 14 for adjusting the air distribution 50 remains in the intermediate position 53 representing the predefined position 53 in the third angular range of rotation 41.

In the fourth angular range of rotation 42, which directly follows the third angular range of rotation 41, the temperature 47 of the air current remains at the maximum temperature 48 as shown in FIG. 8. This means that the second distribution element 19 for adjusting the temperature 47 of the air current remains in the first position 20, in which the entire air current is conveyed around the tempering device 18 through the bypass channel 24. In the third angular range of rotation 41, the first position 20 therefore is a predefined position, in which the second distribution element 19 remains. According to FIG. 9, the air distribution is uniformly adjusted from a uniform distribution into the first zone 27′ and into the second zone 27″ to a distribution into the second zone 27″ only in the third angular range of rotation 42. This means that the first distribution element 14 is adjusted from the intermediate position 53 into the second position 16, in which the outlet 13′ is closed and the outlet 13″ is completely open, in dependence on the rotational angle 45 of the cam plate 28 within the fourth angular range of rotation 42.

In the fifth angular range of rotation 43, which directly follows the fourth angular range of rotation 42, the temperature 47 is uniformly adjusted from the maximum temperature 48 to the minimum temperature 49 as shown in FIG. 8. This means that the second distribution element 19 for adjusting the temperature 47 of the air current is adjusted from the second position 21 into the first position 20 in dependence on the rotational angle 45 in the fifth angular range of rotation 43. According to FIG. 9, the air distribution 50 in the fifth angular range of rotation 43 remains at a distribution into the second zone 27″ only such that the first distribution element 14 for adjusting the air distribution 50 remains in the second position 16 representing the predefined position.

It is therefore possible to adjust one of the distribution elements 14, 19 independently of the other distribution element 14, 19 in the respective angular range of rotation 39, 40, 41, 42, 43 and to thereby adjust the corresponding parameters, in this case the air distribution 50 and the temperature 47, independently of one another. The inventive solution therefore makes it possible to adjust one of the parameters 47, 50 independently of the other parameter 47, 50 by means of a single cam plate 28 within at least one such angular range of rotation 39, 40, 41, 52, 43.

Due to the inventive solution, the overall temperature 47 for all adjustable air distributions 50 therefore can be adjusted with one and the same cam plate.

It is naturally conceivable to predefine other positions for the respective distribution elements 14, 19, in which the distribution elements remain in the respective angular range of rotation 39, 40, 41, 42, 43. This means that any position between the first position 15 and the second position 16 of the first distribution element 14 may serve as such a predefined position of the first distribution element 14 while any position between the first position 20 and the second position 21 of the second distribution element 19 may serve as such a predefined position of the second distribution element 19.

As mentioned above, the rotation of the cam plate 28 and therefore the adjustment of the respective distribution element 14, 19 is realized by means of the control device 12. To this end, the control device 12 may operate automatically based on corresponding stored specifications and/or be manually prompted to carry out a corresponding adjustment of the temperature 47 and the air distribution 50.

1. An air-conditioning system for air-conditioning a space, comprising:
at least one outlet for discharging an air current into the space;
a first distribution element and a second distribution element for adjusting at least one parameter of the air-conditioning system, the first distribution element adjustable over a first adjusting range, and the second distribution element adjustable over a second adjusting range;
a cam plate for adjusting the first distribution element and the second distribution element;
wherein the cam plate features a first guide structure for adjusting the first distribution element and a second guide structure for adjusting the second distribution element;
wherein the guide structures are configured such that the first distribution element remains in a predefined position over a predefined first angular range of rotation of the cam plate, and the second distribution element is adjusted in dependence on a rotational angle of the cam plate in the first angular range of rotation;
wherein the first distribution element is adjusted when the second distribution element is in a predefined position at an end of the second adjusting range; and
wherein the first distribution element is designed for adjusting a first parameter of the air-conditioning system, and the second distribution element is designed for adjusting a second parameter of the air-conditioning system that differs from the first parameter.

2. The air-conditioning system according to claim 1, wherein at least one of the distribution elements is designed for adjusting an air distribution between two outlets.

3. The air-conditioning system according to claim 1, wherein at least one of the distribution elements is designed for adjusting a temperature of the air current.

4. The air-conditioning system according to claim 1, wherein the guide structures are configured such that the first distribution element is adjusted in dependence on the rotational angle of the cam plate over a predefined second angular range of rotation of the cam plate, and the second distribution element remains in a predefined position in the second angular range of rotation.

5. The air-conditioning system according to claim 1, wherein the guide structures are configured such that at least one additional angular range of rotation is provided, wherein one of the distribution elements remains in a predefined position in the respective angular range of rotation, and the other distribution element is adjusted in dependence on the rotational angle of the cam plate.

6. The air-conditioning system according to claim 4, wherein angular ranges of rotation with the predefined position of the first distribution element and angular ranges of rotation with the predefined position of the second distribution element are provided alternately.

7. The air-conditioning system according to claim 1, wherein the distribution element being adjusted over its entire adjusting range in at least one angular range of rotation.

8. The air-conditioning system according to claim 1, wherein the first guide structure and the second guide structure are arranged on opposite sides of the cam plate.

9. The air-conditioning system according to claim 1, wherein the first guide structure and the second guide structure are arranged on the same side of the cam plate.

10. The air-conditioning system according to claim 1, further comprising a drive unit for rotating the cam plate.

11. The air-conditioning system according to claim 1, wherein at least one of the angular ranges of rotation extends over an angle of 10°.

12. The air-conditioning system according to claim 1, wherein at least one of the distribution elements is a flap or features a flap.

13. The air-conditioning system according to claim 1, wherein at least two of the angular ranges of rotation extend over the same angle.

14. The air-conditioning system according to claim 1, wherein at least one of the guide structures is a groove.

15. A method for operating an air-conditioning system according to claim 1, comprising:
adjusting, via the second distribution element a temperature of the air current of the air-conditioning system into different zones of the space; and
adjusting, via the first distribution element, an air distribution of the air-conditioning system into different zones of the space.

16. The method according to claim 15, further comprising:
setting the first distribution element such that the air distribution is directed into one of a first zone and a second zone when the second distribution element is being adjusted from a position in which the temperature is at a maximum value to a position in which the temperature is at a minimum value; and
setting the first distribution element such that the air distribution is directed into the first zone and the second zone when the second distribution element is being adjusted from the position in which the temperature is at the minimum value to the position in which the temperature is at the maximum value.

17. The method according to claim 15, further comprising:
adjusting the air distribution into a first zone of the space in the first angular range of rotation, a temperature of the air current of the air-conditioning system being varied in dependence on the rotational angle of the cam plate;
acting upon the space with a substantially constant temperature of the air current of the air-conditioning system in the second angular range of rotation, which directly follows the first angular range of rotation, the air distribution being varied between a distribution into the first zone and a uniform distribution into the first zone and a second zone of the space in dependence on the rotational angle of the cam plate;
uniformly adjusting the air distribution into the first zone and into the second zone in a third angular range of rotation, which directly follows the second angular range of rotation, the temperature of the air current of the air-conditioning system being varied in dependence on the rotational angle of the cam plate;
maintaining the temperature of the air current of the air-conditioning system to be substantially constant in a fourth angular range of rotation, which directly follows the third angular range of rotation, the air distribution being varied between the uniform distribution into the first zone and the second zone and a distribution into the second zone in dependence on the rotational angle of the cam plate; and
adjusting the air distribution into the second zone in a fifth angular range of rotation, which directly follows the fourth angular range of rotation, the temperature of the air current of the air-conditioning system being varied in dependence on the rotational angle of the cam plate.

18. A motor vehicle comprising an interior and an air-conditioning system for air-conditioning the interior, the air-conditioning system having:
at least one outlet for discharging an air current into the space;
a first distribution element and a second distribution element for adjusting at least one parameter of the air-conditioning system, the first distribution element adjustable over a first adjusting range, and the second distribution element adjustable over a second adjusting range;
a cam plate for adjusting the first distribution element and the second distribution element;
wherein the cam plate features a first guide structure for adjusting the first distribution element and a second guide structure for adjusting the second distribution element;
wherein the guide structures are configured such that the first distribution element remains in a predefined position over a predefined first angular range of rotation of the cam plate, and the second distribution element is adjusted in dependence on a rotational angle of the cam plate in the first angular range of rotation;
wherein the first distribution element is adjusted when the second distribution element is in a predefined position at an end of the second adjusting range; and
wherein the first distribution element is designed for adjusting a first parameter of the air-conditioning system, and the second distribution element is designed for adjusting a second parameter of the air-conditioning system that differs from the first parameter.

19. The motor vehicle according to claim 18, further comprising a control device configured to:
adjust, via the second distribution element, a temperature of the air current of the air-conditioning system into different zones of the space; and
adjust, via the first distribution element, an air distribution of the air-conditioning system into different zones of the space.

20. The motor vehicle according to claim 18, wherein the distribution elements are designed for air-conditioning a rear region of the interior.
